(19) United States
(12) Patent Application Publication
(10) Pub. No.: US 2008/0023042 A1
(43) Pub. Date: Jan. 31, 2008

(54) Method and apparatus for reducing water consumption in a dishwashing cleaning cycle

(75) Inventor: Amit David Jayakaran, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/496,559

(22) Filed: Jul. 31, 2006

(51) Int. Cl. B08B 7/04; B08B 9/20; B08B 3/00

(52) U.S. Cl. 134/25.2; 134/26; 134/56 D; 134/18

(57) ABSTRACT

A dishwasher includes an inlet port for filling the dishwasher with fresh wash liquid, a wash chamber for collecting the wash liquid, and a discharge port fluidly coupled to the wash chamber for purging used wash liquid. The dishwasher further includes a control system operatively coupled to the inlet port and to the discharge port to control partial filling and partial purging of the wash liquid.

### BACKGROUND

Embodiments of the invention relate generally to dishwashers, and more particularly to a dishwasher control system.

Various types of dishwashers are known and are currently in use. For example, a spray dishwasher used for domestic applications uses detergent dissolved in warm water that is sprayed within the dishwasher cabinet to wash dishes (including but not limited to plates, saucers, cups utensils, pots and pans, silverware, etc.) arranged in racks. In particular, the spray dishwasher employs devices for spraying water such as a one or more rotating spray arms that spray water through multiple holes formed on the arms, a wash reservoir or “sump” in which water is collected and a pump to pump the water from the sump to the spray arms.

A single cleaning cycle of a dishwasher may include a pre-wash cycle, a wash cycle, a rinse cycle and a drying or sanitation cycle. The pre-wash cycle is designed to remove the larger and more easily removable particles from the surface of the dishes to be washed, while the wash cycle is designed to remove all other soil and particulates from the dishes. The rinse cycle is used to remove residual detergent remaining on the dishes after completion of the wash cycle. Lastly, the drying or sanitization stage is used to dry the dishes and remove any bacteria that may remain on the dishes despite completion of the previous cycles. Moreover, each such cycle may in turn include one or more cleaning stages. For example, each pre-wash cycle may include multiple pre-wash stages, each wash cycle may include multiple wash stages, and each rinse cycle may include multiple rinse stages.

The number and types of independent cleaning stages performed in a given cleaning cycle may vary as a function of user preference or manufacturer design based upon, e.g. a desired wash performance also referred to as washability. In a conventional dishwasher, each cleaning stage typically begins with the complete filling of a sump and subsequently ends with the complete emptying of the sump. Depending upon the number of pre-wash, wash, and rinse stages utilized and the volume of the dishwasher's sump, the amount of water consumed in a single cleaning cycle of a single dishwasher can be large. Such water consumption is only compounded by the number of cleaning cycles performed within by a single household year and the number of households that use at least one dishwasher. As a result, the costs incurred by consumers and the environment due to unnecessary water consumption is notably large.

### BRIEF DESCRIPTION

Briefly, according to one embodiment, a method of performing a dishwasher cleaning cycle having a plurality of cleaning stages is provided. The method includes filling a wash chamber with a first volume of a wash liquid, performing a first cleaning stage and purging a second volume of wash liquid from the wash chamber after the first cleaning stage wherein the second volume is less than the first volume. The method further includes supplying a diluting volume of fresh wash liquid to the wash chamber, and performing at least one subsequent cleaning stage.

In another embodiment, a dishwasher is provided. The dishwasher includes an inlet port for filling the dishwasher with fresh wash liquid, a wash chamber for collecting the wash liquid, a discharge port fluidly coupled to the sump for purging used wash liquid, and a control system operatively coupled to the inlet port and to the discharge port to control filling and purging of the wash liquid. The control system is further configured to fill the wash chamber with a first volume of fresh wash liquid, perform a first cleaning stage, and purge a second volume of used wash liquid from the discharge port after the first cleaning stage, wherein the second volume is less than the first volume. The control system is further configured to supply the wash chamber with a diluting volume of fresh wash liquid from the inlet port and perform at least one subsequent cleaning stage.

In a further embodiment, a second method of performing a cleaning cycle having a plurality of cleaning stages is provided. The method includes filling the wash chamber of a dishwasher with a first volume of a wash liquid and performing a first cleaning stage. The cleaning cycle is then paused to allow for sedimentation of food particles within the wash liquid of the wash chamber and a second volume of wash liquid and sedimented food particles is purged from the wash chamber, wherein the second volume is a fractional portion of the first volume. The method further includes providing a volume of fresh wash liquid to the wash chamber, wherein the volume of fresh wash liquid is substantially equal to the purged second volume of wash liquid, and performing at least one subsequent cleaning stage.

### DRAWINGS

These and other features, aspects, and advantages of the present invention will become better understood when the following detailed description is read with reference to the accompanying drawings in which like characters represent like parts throughout the drawings, wherein:

FIG. 1 is a side sectional view of a dishwasher in which embodiments of the present invention may be practiced;

FIG. 2 illustrates a schematic diagram of control system 137 in accordance with one embodiment;

FIG. 3 is a top plan view of dishwasher 100 just above lower spray arm assembly 144;

FIG. 4 is a schematic diagram illustrating one embodiment of fluid circulation assembly 170;

FIG. 5 is an operational flow diagram illustrating operation of control system 137 in accordance with one embodiment of the present invention; and

FIG. 6 graphically illustrates operation of fluid circulation assembly 170 in performance of a low water consumption cleaning cycle accordance with one embodiment of the invention.

### DETAILED DESCRIPTION

As discussed in detail below, embodiments of the present invention relate to a method and apparatus for performing a dishwasher cleaning cycle that utilizes decreased amounts of water over conventional cleaning apparatuses. In the following detailed description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, well known methods, procedures, and components have not been described in detail.

Furthermore, various operations may be described as multiple discrete steps performed in a manner that is helpful for understanding embodiments of the present invention. However, unless otherwise noted the order of description should not be construed as to imply that these operations need be performed in the order they are presented, nor that they are even order dependent. Moreover, repeated usage of the phrase “in one embodiment” does not necessarily refer to the same embodiment, although it may. Lastly, the terms “comprising”, “including”, “having”, and the like, as well as their inflected forms as used in the present application, are intended to be synonymous unless otherwise indicated.

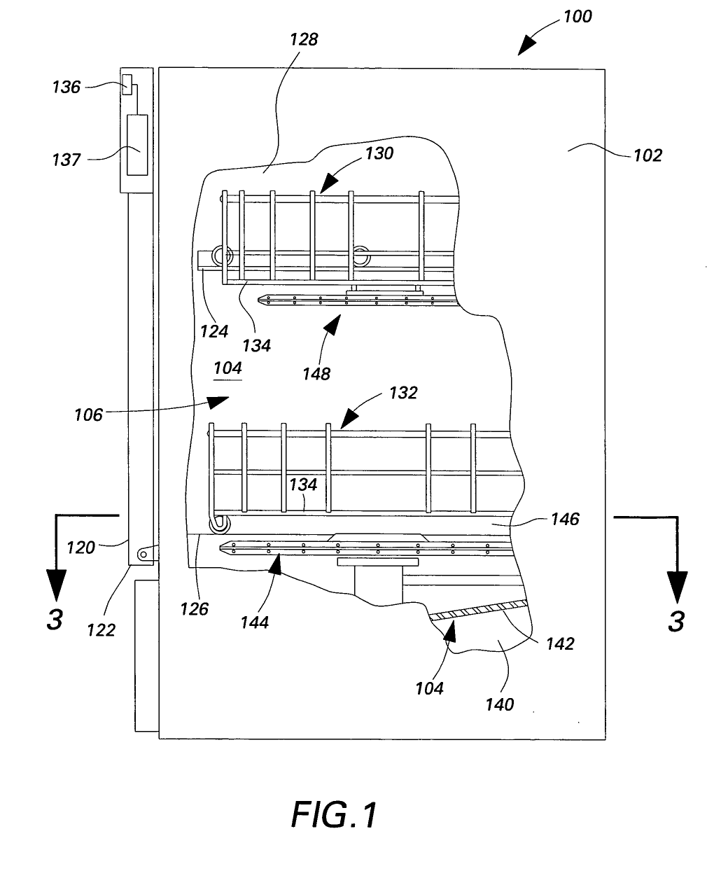

FIG. 1 is a side elevational view of an exemplary domestic dishwasher system 100 partially broken away, and in which embodiments of the present invention may be practiced. It is contemplated, however, that embodiments of the invention may be practiced in other types of dishwashers and dishwasher systems beyond dishwasher system 100 described and illustrated herein. Accordingly, the following description is for illustrative purposes only, and the invention is in no way limited to use in a particular type of dishwasher system, such as dishwasher system 100.

Dishwasher 100 includes a cabinet 102 having a tub 104 therein and forming a wash chamber 106. Tub 104 includes a front opening (not shown in FIG. 1) and a door 120 hinged at its bottom 122 for movement between a normally closed vertical position (shown in FIG. 1) wherein wash chamber is sealed shut for washing operation, and a horizontal open position (not shown) for loading and unloading of dishwasher contents. Upper and lower guide rails 124, 126 are mounted on tub side walls 128 and accommodate upper and lower roller-equipped racks 130, 132, respectively. Each of upper and lower racks 130, 132 is fabricated from known materials into lattice structures including a plurality of elongate members 134, and each rack 130, 132 is adapted for movement between an extended loading position (not shown) in which the rack is substantially positioned outside wash chamber 106, and a retracted position (shown in FIG. 1) in which the rack is located inside wash chamber 106. A silverware basket (not shown) may be removably attached to lower rack 132 for placement of silverware, utensils, and the like that are too small to be accommodated by upper and lower racks 130, 132.

Dishwasher 100 further includes a lower spray-arm-assembly 144 that is rotatably mounted within a lower region 146 of wash chamber 106 and above tub sump portion 142 so as to rotate in relatively close proximity to lower rack 132. A mid-level spray-arm assembly 148 is located in an upper region of wash chamber 106 and may be located in close proximity to upper rack 130. Additionally, an upper spray arm assembly (not shown) may be located above upper rack 130.

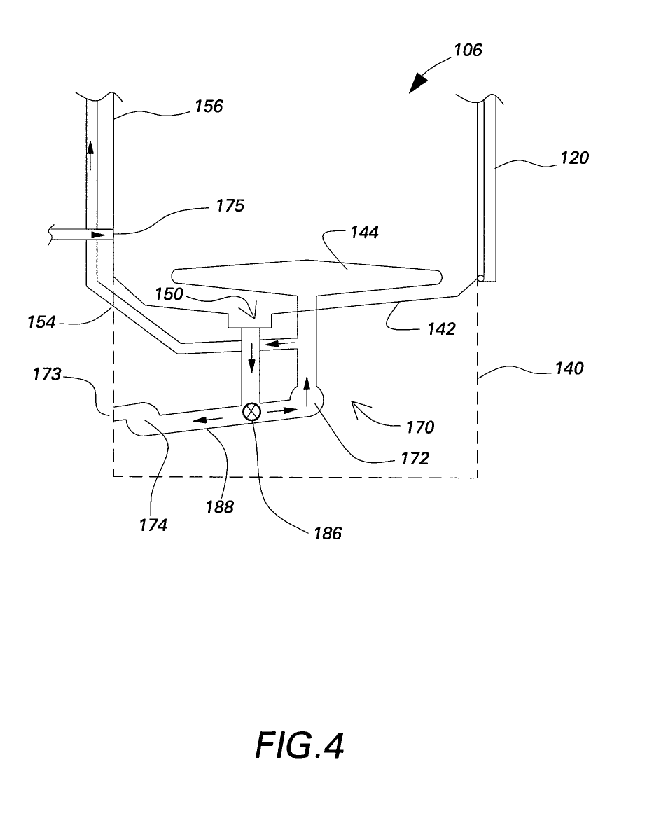

Lower and mid-level spray-arm assemblies 144, 148 and the upper spray arm assembly are fed by a fluid circulation assembly (shown in FIG. 4) for circulating water and dishwasher fluid in dishwasher tub 104. In one embodiment, the fluid circulation assembly is located in a machinery compartment 140 located below a bottom sump portion 142 of tub 104 as described in further detail below. Each spray-arm assembly includes an arrangement of discharge ports or orifices for directing washing liquid onto dishes located in upper and lower racks 130, 132, respectively. The arrangement of the discharge ports in at least lower spray-arm assembly 144 provides a rotational force by virtue of washing fluid flowing through the discharge ports. The resultant rotation of lower spray-arm assembly 144 provides coverage of dishes and other dishwasher contents with a washing spray.

Dishwasher 100 is further equipped with a control system 137 to regulate operation of dishwasher 100. Control system 137 may be positioned in a variety of locations throughout dishwasher 100. In one embodiment, control system 137 may be located within a control panel area of door 120 as shown. In such an embodiment, input/output (“I/O”) signals may be routed between the control system and various operational components of dishwasher 100 along wiring harnesses that may be routed through the bottom 122 of door 120. In one embodiment, control system 137 may include a user interface 136 through which a user may control and monitor operation of dishwasher 100.

In accordance with one embodiment of the invention, control system 137 is operable to control the fluid circulation assembly to perform a variety of cleaning cycles within dishwasher 100 including at least a low water consumption cleaning cycle (as described in further detail below). The low water consumption cleaning cycle described herein may include a series of cleaning stages such as one or more pre-wash stages, one or more wash stages, one or more rinse stages and a drying/sanitizing stage. In accordance with one embodiment of the present invention, control system 137 may be operable to perform a low water consumption cleaning cycle by purging a fractional volume of dirty or used wash liquid from wash chamber 106 after one cleaning stage is performed, and supplying a diluting amount of fresh wash liquid to wash chamber 106 before a subsequent cleaning stage is performed. It has been found that by purging and refilling only a portion of the wash liquid, a significant amount of water can be saved during each cleaning cycle without a corresponding decrease in washability. Such a low water consumption cleaning cycle may be contrasted with conventional dishwasher cleaning cycles that are designed to completely empty and refill their respective wash chambers before beginning a subsequent stage. In doing so, such conventional dishwashers typically utilize large volumes of water to complete each traditional cleaning cycle.

In one embodiment, control system 137 may be configured to pause for a period of time before the fractional volume of wash liquid is purged from the wash chamber 106 in order to facilitate sedimentation of food particles released from the dishes during a previous cleaning stage. Such a sedimentation stage contributes to a large percentage of particulates being removed during the partial purge stage even though only a small volume of wash liquid is removed. Furthermore, by replacing the purged volume of wash liquid with a small volume of fresh wash liquid, the soiled wash liquid remaining in the wash chamber is diluted thereby maintaining high washability of dishwasher 100.

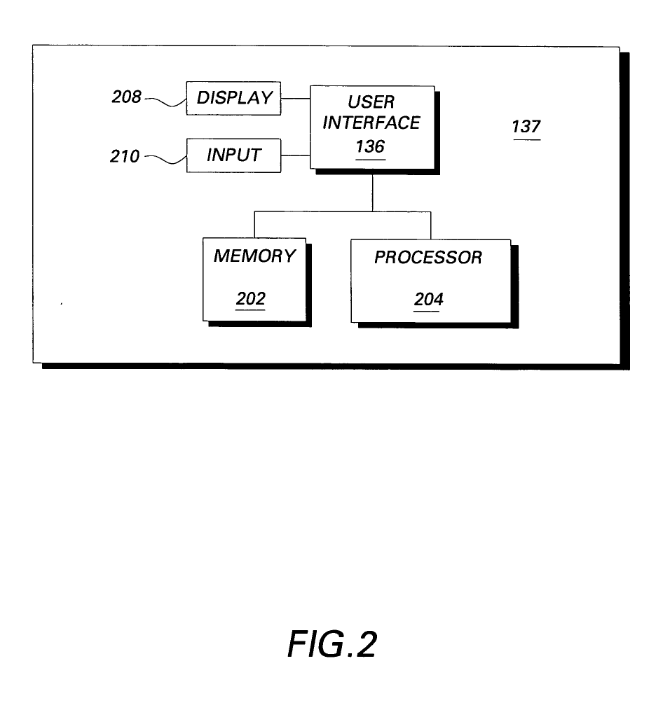

FIG. 2 illustrates a schematic diagram of control system 137 in accordance with one embodiment. As shown, control system 137 may include user interface 136, memory 202, and processor 204. In one embodiment, user interface 136 may represent a general purpose I/O (“GPIO”) device or functional block. In one embodiment, user interface 136 may include input component 210 and display component 208 as shown. In one embodiment, input component 210 may represent one or more of a variety of electrical, mechanical or electro-mechanical input devices including rotary dials, push buttons, and touchpads. In one embodiment, display component 208 may represent a digital or analog display device designed to provide operational feedback to a user. User interface 136 may be communicatively coupled to processor 204 and memory 202 via one or more signal lines or shared communication busses. Processor 204 may represent a general or special purpose microprocessor operable to execute programming instructions or micro-control code associated with a cleaning cycle. Memory 202 may represent random access memory such as DRAM, or read only memory such as ROM or FLASH. In one embodiment, processor 204 executes programming instructions stored in memory 202. Although depicted as separate components in FIG. 2, memory 202 may instead be included onboard within processor 204. In one embodiment, processor 204 may execute programming instructions, which are operable to cause dishwasher 100 to perform a low water consumption cleaning cycle.

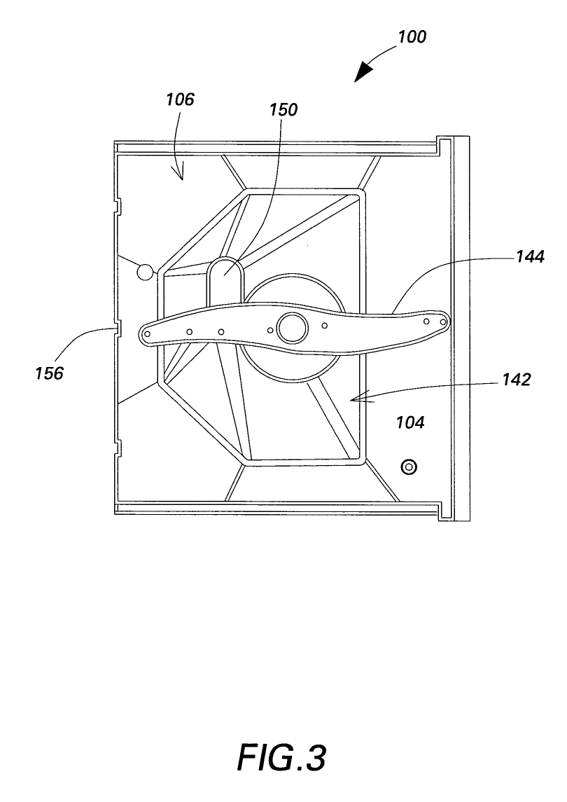

FIG. 3 is a top plan view of a dishwasher system 100 just above lower spray arm assembly 144. Tub 104 is generally downwardly-sloped beneath lower spray arm assembly 144 toward tub sump portion 142, and tub sump portion is generally downwardly sloped toward a sump 150 in flow communication with the fluid circulation assembly (shown in FIG. 4). In the illustrated embodiment, lower spray arm assembly is substantially centered within tub 104 and wash chamber 106, off-centered with respect to tub sump portion 142, and positioned above tub 104 and tub sump portion 142 to facilitate free rotation of spray arm 144. Tub 104 and tub sump portion 142 are downwardly sloped toward sump 150 so that as wash liquid sprayed from lower spray arm assembly 144, mid-level spray arm assembly 148 (shown in FIG. 1) and the upper spray arm assembly (not shown) is collected in tub sump portion 142 and directed toward sump 150 for filtering and re-circulation during a dishwasher system wash cycle.

FIG. 4 illustrates fluid circulation assembly 170 in accordance with one embodiment. Although one embodiment of a fluid circulation assembly that is operable to perform aspects of a low water consumption cleaning cycle is shown, it is contemplated that other fluid circulation assembly configurations may similarly be utilized without departing from the spirit and scope of the invention. As shown, fluid circulation assembly 170 extends below wash chamber 106 in machinery compartment 140. Fluid circulation assembly 170 includes a circulation pump assembly 172 and a drain pump assembly 174, both in fluid communication with sump 150. Additionally, drain pump assembly 174 is in fluid communication with an external drain to discharge used wash liquid. Further, circulation pump assembly 172 is in fluid communication with lower spray arm assembly 144 and conduit 154 which extends to a back wall 156 of wash chamber 106, and upward along back wall 156 for feeding wash liquid to mid-level spray arm assembly 148 and the upper spray arm assembly.

As wash liquid is pumped through lower spray arm assembly 144, and further delivered to mid-level spray arm assembly 148 (shown in FIG. 1) and the upper spray arm assembly (not shown), washing sprays are generated in wash chamber 106, and wash liquid collects in sump 150. Sump 150 may include a cover to prevent larger objects from entering sump 150, such as a piece of silverware or another dishwasher item that is dropped beneath lower rack 132 (shown in FIG. 1). A course filter and a fine filter (not shown) may be located adjacent sump 150 to filter wash liquid for sediment and particles of predetermined sizes before flowing into sump 150. Furthermore, a turbidity sensor may be coupled to sump 150 and used to sense a level of sediment in sump 150 and to initiate a sump purge cycle where the contents or a fractional volume of the contents of sump 150 are discharged when a turbidity level in sump 150 approaches a predetermined threshold. In turn, control system 137 may open a valve at inlet port 175 to refill sump 150 with a volume of fresh wash liquid (e.g. water) substantially equal to the fractional volume of wash liquid discharged through a previous purge cycle.

In one embodiment, a drain valve 186 is established in flow communication with sump 150 and opens or closes flow communication between sump 150 and a drain pump inlet 188. Drain pump assembly 174 is in flow communication with drain pump inlet 188 and may include an electric motor for pumping fluid at inlet 188 to an external drain system. In one embodiment, when drain pump is energized, a negative pressure is created in drain pump inlet 188 and drain valve 186 is opened, allowing fluid in sump 150 to flow into fluid pump inlet 188 and be discharged from fluid circulation assembly 170.

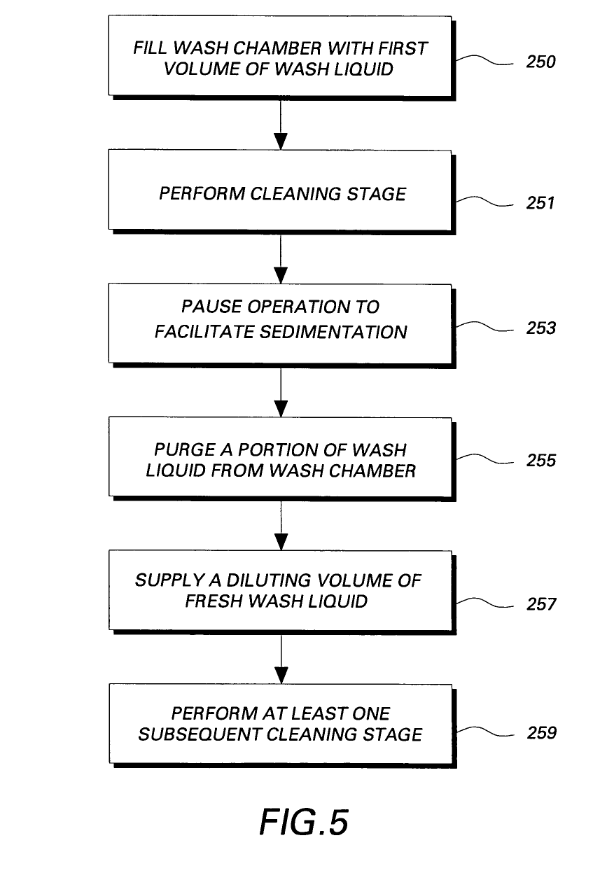

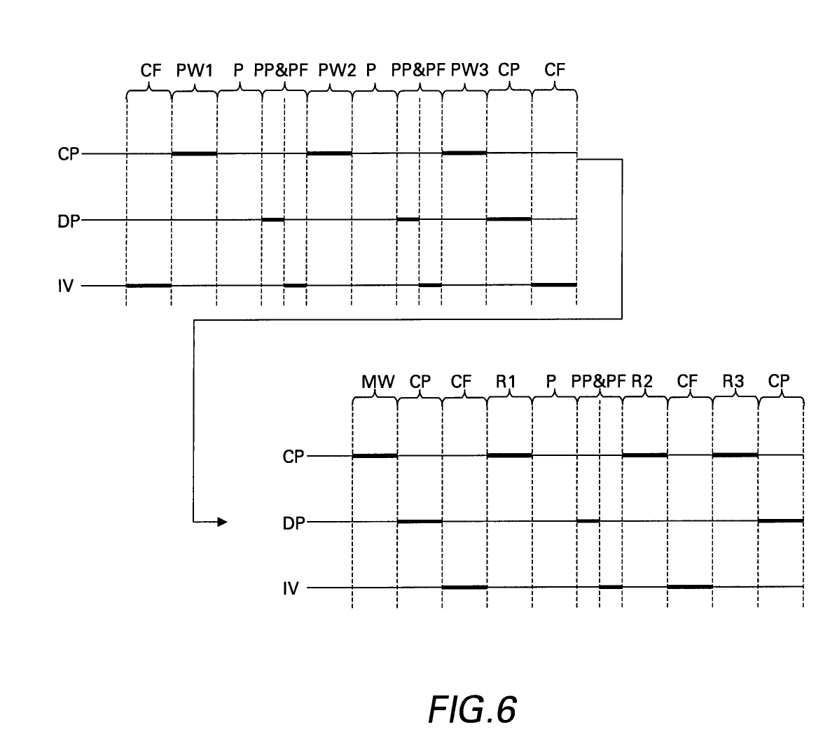

Reference is now made to FIGS. 5 and 6 in which an example operation of a low water consumption cleaning cycle within dishwasher 100 is illustrated. FIG. 5 is an operational flow diagram illustrating operation of control system 137 in accordance with one embodiment of the present invention. In accordance with the illustrated embodiment, the low water consumption cleaning cycle begins at block 250 with a wash chamber, such as wash chamber 106 or more specifically, sump 150 being filled with a first volume of wash liquid. In one embodiment, control system 137 provides one or more control signals for drain valve 186 to close and a valve at inlet port 175 to open such that wash liquid collects in sump 150. Once a sufficient volume of was liquid has been collected, dishwasher 100 performs at least one cleaning stage of a cleaning cycle at block 251. During such a cleaning stage, drain valve 186 may be opened and circulation pump assembly 172 may be operated to circulate wash liquid throughout wash chamber 106. Once a cleaning stage has completed, a volume of wash liquid is purged from wash chamber 106 (and in particular from sump 150) at block 255. In one embodiment, the volume of wash liquid that is purged is less than the amount of wash liquid provided in the previous fill stage. In one embodiment, the volume of wash liquid that is purged from wash chamber 106 is between about 20 percent and about 50 percent of the wash liquid fill volume. In one embodiment, the amount of wash liquid that is purged from wash chamber 106 decreases for each successive purge cycle.

In one embodiment, control system 137 may actively pause operation of dishwasher 100 (as shown at block 253) to facilitate sedimentation of food particles within the wash liquid of sump 150. Such purposeful sedimentation enables additional food particles to be removed from the wash liquid during the purge cycle. This is desirable since, in accordance with embodiments of the present invention, only a portion of the wash liquid is being purged from wash chamber 106. This can be contrasted with conventional dishwasher purge cycles that operate to discard all of the wash liquid from the wash chamber after performance of a cleaning stage. Although the longer the wash liquid is allowed to settle the more sedimentation that is likely to occur, this also increases the time it takes to complete the cleaning cycle. In one embodiment, the cleaning cycle is paused and the wash liquid is allowed to settle for at least two minutes, which provides an acceptable tradeoff between washability performance and cleaning cycle time.

Once a fractional volume of wash liquid is purged from wash chamber 106 at block 255, a diluting volume of fresh wash liquid is supplied to wash chamber 106 at block 257. In one embodiment, control system 137 may open a valve at inlet port 175 to refill sump 150 with the diluting volume of fresh wash liquid. In one embodiment, the diluting volume of fresh wash liquid may be substantially equal to the volume of wash liquid that was discarded in the previous purge stage. Moreover, the diluting volume of fresh wash liquid may be substantially less than the volume of wash liquid supplied to wash chamber 106 during a fill cycle such as that illustrated by block 250. At block 259 dishwasher 100 performs at least one subsequent cleaning stage as part of the low waster usage cleaning cycle. In one embodiment, control system 137 may be configured to perform a partial purge and partial fill of the wash liquid between is a first pre-wash stage and a second pre-wash stage of a cleaning cycle. In one embodiment, control system 137 may be configured to perform a partial purge and partial fill of the wash liquid between a pre-wash stage and the subsequent wash stage of a cleaning cycle. In a further embodiment, control system 137 may be configured to perform a partial purge and partial fill of the wash liquid between a first rinse stage and a subsequent rinse stage of a cleaning cycle.

FIG. 6 graphically illustrates operation of fluid circulation assembly 170 in performance of a low water consumption cleaning cycle accordance with one embodiment of the invention. In the illustrated cleaning cycle, the process begins with a complete fill (CF) of wash chamber 106. During a complete fill process, control system 137 may open an inlet valve (IV) to provide fresh wash liquid through inlet port 175 while the circulation pump assembly 172 (CP) and drain pump assembly 174 (DP) are not active. During a first pre-wash stage (PW1), CP is active while DP is idle and IV is closed. After the first pre-wash stage, control system 137 pauses operation (P) of dishwasher 100 before performing a partial purge (PP) and partial fill (PF) as previously described. During the PP stage DP is active to purge wash liquid from wash chamber 106 while CP is idle and IV is closed. After a determined portion of the wash liquid has been removed, DP is shut off and IV is opened while CP remains idle. Once wash chamber 106 has been refilled during the partial fill stage, a second pre-wash (PW2) is performed whereby CP is activated and IV is closed while DP remains idle. After the PW2 stage control system 137 pauses operation of dishwasher 100 to facilitate sedimentation of any food particles within the wash liquid. Thereafter, another partial purge and partial fill stage are commenced and another pre-wash stage (PW3) is run. This pre-wash, pause, partial purge/partial fill cycle may be repeated any number of times as may be desired.

After the pre-wash stages are complete, control system 137 initiates a complete purge (CP) and another complete fill (CF) before the main wash (MW) stage is commenced. During the MW stage, CP is active while IV is closed and DP remains closed. In the illustrated embodiment the MW stage is followed by a complete purge and a complete fill, however a partial purge and partial fill could instead be used if additional wash cycles were to be utilized. After the MW stage, control system 137 initiates a series of rinse cycles (R1, R2, R3) where CP is active IV is closed and DP is idle. In accordance with the illustrated embodiment, a pause stage and subsequent partial purge and partial fill stages are performed after at least the first rinse stage. The low water consumption cleaning cycle ends with a complete purge (CP) of wash chamber 106.

### EXAMPLES

Applicant has found that by replacing one or more complete purge and fill stages of a conventional dishwasher cycle with a corresponding partial purge and partial fill stage as described above, a decrease in water usage can be recognized. Furthermore, by adding a pause stage before the partial purge and partial fill stage, improved washability can be achieved. The following tables illustrate estimated water usage and washability for a conventional dishwasher cleaning cycle (Table 1) and four low water consumption cleaning cycles (Tables 2-5) as may be performed by dishwasher 100 and control system 137 as described herein.

In the example illustrated below, a sump having a volume of 5.3 liters was utilized. Overall washability for a given cleaning cycle is reflected by a wash index where the wash index for a given cleaning cycle is estimated through a washability test. Typically, food items are applied on dishes about 24 hours prior to the washability test and are then washed in the dishwasher. Further, the washed dishes are graded at the end of the cycle for estimating the wash index. The dishes are graded on a scale of 0, 3 and 8, 0 where 0 is assigned to a perfectly clean dish, 3 is assigned to a dish where any remaining soil can be flicked off with relatively less effort and 8 being assigned to a dish where any remaining soil regardless of its size cannot be flicked off the dish or can be flicked of but leaves a mark on the dish. The grading is performed for all the dishes washed in the dishwasher and the wash index is estimated by the following equation:

$$Wash Index = 100 ( 1 - \frac{a}{8 N} ) \qquad ( 1 )$$

Where: α is summation of all assigned points; and
N is number of pieces in the load for the cycle of the dishwasher.
   As can be seen, the water consumption by dishwasher 100 reflected in Tables 2-5 is relatively lesser than that of the conventional cleaning cycle as reflected in Table 1. Furthermore, even with reduced water consumption, high washability can be achieved.

TABLE 1
Conventional Cleaning Cycle

| | | |
|---|---|---|
| +5.3 L complete fill | Prewash 1 | −5.3 L complete purge |
| +5.3 L complete fill | Prewash 2 | −5.3 L complete purge |
| +5.3 L complete fill | Prewash 3 | −5.3 L complete purge |
| +5.3 L complete fill | Wash 1 | −5.3 L complete purge |
| +5.3 L complete fill | Rinse 1 | −5.3 L complete purge |
| +5.3 L complete fill | Rinse 2 | −5.3 L complete purge |
| +5.3 L complete fill | Rinse 3 | −5.3 L complete purge |

Total water usage = 37.1 liters

TABLE 2
Low water consumption Cleaning Cycle 1

| | | |
|---|---|---|
| +5.3 L complete fill | Prewash 1 | −5.3 L complete purge |
| +5.3 L complete fill | Prewash 2 | −1 L partial purge |
| +1 L partial fill | Prewash 3 | −5.3 L complete purge |
| +5.3 L complete fill | Wash 1 | −5.3 L complete purge |
| +5.3 L complete fill | Rinse 1 | −5.3 L complete purge |
| +5.3 L complete fill | Rinse 2 | −5.3 L complete purge |
| +5.3 L complete fill | Rinse 3 | −5.3 L complete purge |

Total water usage = 33.1 Liters
Wash index = 99

TABLE 3
Low water consumption Cleaning Cycle 2

| | | |
|---|---|---|
| +5.3 L complete fill | Prewash 1 | −1 L partial purge |
| +1 L partial fill | Prewash 2 | −1 L partial purge |
| +1 L partial fill | Prewash 3 | −5.3 L complete purge |
| +5.3 L complete fill | Wash 1 | −5.3 L complete purge |
| +5.3 L complete fill | Rinse 1 | −5.3 L complete purge |
| +5.3 L complete fill | Rinse 2 | −5.3 L complete purge |
| +5.3 L complete fill | Rinse 3 | −5.3 L complete purge |

Total water usage = 29.1 Liters
Wash index = 97

TABLE 4
Low water consumption Cleaning Cycle 3

| | | | |
|---|---|---|---|
| +5.3 L complete fill | Prewash 1 | Pause | −1 L partial purge |
| +1 L partial fill | Prewash 2 | Pause | −1 L partial purge |
| +1 L partial fill | Prewash 3 | | −5.3 L complete purge |
| +5.3 L complete fill | Wash 1 | | −5.3 L complete purge |
| +5.3 L complete fill | Rinse 1 | | −5.3 L complete purge |
| +5.3 L complete fill | Rinse 2 | | −5.3 L complete purge |
| +5.3 L complete fill | Rinse 3 | | −5.3 L complete purge |

Total water usage = 29.1 Liters
Wash index = 98

TABLE 5
Low water consumption Cleaning Cycle 4

| | | | |
|---|---|---|---|
| +5.3 L complete fill | Prewash 1 | Pause | −1 L partial purge |
| +1 L partial fill | Prewash 2 | Pause | −1 L partial purge |
| +1 L partial fill | Prewash 3 | | −5.3 L complete purge |
| +5.3 L complete fill | Wash 1 | | −5.3 L complete purge |
| +5.3 L complete fill | Rinse 1 | Pause | −1 L partial purge |
| +1 L partial fill | Rinse 2 | | −5.3 L complete purge |
| +5.3 L complete fill | Rinse 3 | | −5.3 L complete purge |

Total water usage = 24.2 Liters
Wash index = 100

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of performing a dishwasher cleaning cycle having a plurality of cleaning stages, the method comprising:
filling a wash chamber with a first volume of a wash liquid;
performing a first cleaning stage;
purging a second volume of wash liquid from the wash chamber after the first cleaning stage, wherein the second volume is less than the first volume;
supplying a diluting volume of fresh wash liquid to the wash chamber; and
performing at least one subsequent cleaning stage.

2. The method of claim 1, further comprising:
pausing the cleaning cycle before purging the second volume of wash liquid to allow for sedimentation of food particles within the wash chamber.

3. The method of claim 2, wherein pausing a cleaning cycle comprises pausing the cleaning cycle for at least two minutes before purging the second volume of wash liquid.

4. The method of claim 2, wherein the first cleaning stage is a first pre-wash stage and the subsequent cleaning stage is a second pre-wash stage.

5. The method of claim 2, wherein the first cleaning stage is a pre-wash stage and the subsequent cleaning stage is a wash stage.

6. The method of claim 2, wherein the first cleaning stage is a first rinse stage and the subsequent cleaning stage is a second rinse stage.

7. The method of claim 1, wherein purging a second volume of wash liquid from the wash chamber comprises purging a second volume of wash liquid that ranges from about 20 percent to about 50 percent of the first volume.

8. The method of claim 1, wherein the diluting volume of fresh wash liquid is substantially equal to the second volume.

9. The method of claim 1, wherein the diluting volume of fresh wash liquid is substantially less than the first volume.

10. A control system operable to perform the method of claim 1.

11. A dishwasher comprising:
an inlet port for filling the dishwasher with fresh wash liquid;
a wash chamber for collecting the wash liquid;
a discharge port fluidly coupled to the wash chamber for purging used wash liquid; and
a control system operatively coupled to the inlet port and to the discharge port to control filling and purging of the wash liquid, the control system configured to
fill the wash chamber with a first volume of fresh wash liquid,
perform a first cleaning stage,
purge a second volume of used wash liquid from the discharge port after the first cleaning stage, wherein the second volume is less than the first volume,
supply the wash chamber with a diluting volume of fresh wash liquid from the inlet port, and
perform at least one subsequent cleaning stage.

12. The dishwasher of claim 11, wherein the control system is further configured to pause the cleaning cycle before purging the second volume of used wash liquid to allow for sedimentation of food particles within the used wash liquid.

13. The dishwasher of claim 12, wherein the control system is configured to pause the cleaning cycle for at least two minutes before purging the second volume of used wash liquid.

14. The dishwasher of claim 11, wherein the control system is configured to purge a second volume of used wash liquid that ranges from about 20 percent to about 50 percent of the first volume.

15. The dishwasher of claim 11, wherein the diluting volume of wash liquid is substantially equal to the second volume.

16. The dishwasher of claim 11, wherein the diluting volume of fresh wash liquid is substantially less than the first volume.

17. In a dishwasher, a method of performing a cleaning cycle having a plurality of cleaning stages, the method comprising:
filling the wash chamber with a first volume of a wash liquid;
performing a first cleaning stage;
pausing the cleaning cycle to allow for sedimentation of food particles within the wash liquid of the wash chamber;
purging a second volume of wash liquid and sedimented food particles from the wash chamber, wherein the second volume is a fractional portion of the first volume;
providing a volume of fresh wash liquid to the wash chamber, wherein the volume of fresh wash liquid is substantially equal to the purged second volume of wash liquid; and
performing at least one subsequent cleaning stage.
